(19) United States
(12) Patent Application Publication
(10) Pub. No.: US 2013/0110371 A1
(43) Pub. Date: May 2, 2013

(54) DRIVING ASSISTING APPARATUS AND DRIVING ASSISTING METHOD

(71) Applicant: Yuki OGAWA, Toyota-shi (JP)

(72) Inventor: Yuki OGAWA, Toyota-shi (JP)

(21) Appl. No.: 13/666,381

(22) Filed: Nov. 1, 2012

(30) Foreign Application Priority Data
Nov. 1, 2011 (JP) 2011-240590

(51) Int. Cl. G06F 17/00

(52) U.S. Cl. 701/70; 701/1

(57) ABSTRACT

A driving assisting apparatus that assists in driving a vehicle includes: a vehicle speed sensor that detects a vehicle speed of the vehicle; a control unit that determines a recommended traveling state based on a current vehicle speed detected by the vehicle speed sensor and at least one of an accelerated vehicle speed when the vehicle accelerates from the current vehicle speed at an allowable acceleration and a decelerated vehicle speed when the vehicle decelerates from the current vehicle speed at an allowable deceleration; and an assisting unit that assists in driving the vehicle based on the recommended traveling state determined by the control unit.

### INCORPORATION BY REFERENCE

The disclosure of Japanese Patent Application No. 2011-240590 filed on Nov. 1, 2011 including the specification, drawings and abstract is incorporated herein by reference in its entirety.

### BACKGROUND OF THE INVENTION

1. Field of the Invention

The present invention relates to a driving assisting apparatus and a driving assisting method.

2. Description of Related Art

Recently, a driving assisting apparatus is mounted on some vehicles, such as an automobile, to assist a driver in driving. For example, Japanese Patent Application Publication No. 2009-289007 and Japanese Patent Application Publication No. 2008-296783 describe a driving assisting apparatus that assists a driver in traveling so that the driver can pass through an intersection smoothly based on the vehicle's traveling state and the traffic light state. Japanese Patent Application Publication No. 2009-289007 describes a vehicle-speed display method for an intersection non-stopping traveling control system. According to this method, with a recommended traveling speed or a corrected recommended traveling speed displayed in a fixed position on the display screen as a reference value, the vehicle's actual traveling speed is displayed as a value relative to the reference value in a manner that the actual traveling speed is compared with the recommended traveling speed or the corrected recommended traveling speed. Japanese Patent Application Publication No. 2008-296783 describes an in-vehicle apparatus. This in-vehicle apparatus determines whether the host vehicle is in a dangerous traveling state determined by a stop condition and an intersection-entering condition, based on the distance to the stop line, the speed of the host vehicle, the yellow light start time and the yellow light duration of the traffic light at an intersection, and a predetermined standard deceleration. The stop condition refers to a condition for the host vehicle to stop before an intersection at the start of the yellow light, and the intersection-entering condition refers to a condition for the host vehicle to enter an intersection at the end of the yellow light. If it is determined that the host vehicle is in a dangerous traveling state, the in-vehicle apparatus performs the following processing to avoid a dangerous traveling state. For example, the in-vehicle apparatus decelerates the host vehicle at low deceleration to stop it at the stop line, or accelerates the host vehicle at low acceleration to cause it to enter the intersection.

The apparatus described in Japanese Patent Application Publication No. 2009-289007 or Japanese Patent Application Publication No. 2008-296783 displays a recommended traveling speed or acceleration- or deceleration-prompting information to notify a driver about a traveling condition to safely pass through an intersection. However, according to the apparatus described in Japanese Patent Application Publication No. 2009-289007 or Japanese Patent Application Publication No. 2008-296783, the difference between a recommended traveling speed or an instructed acceleration and the current traveling state is so great that a driver sometimes has to drive the vehicle under severe conditions in order to achieve the recommended traveling speed or the instructed acceleration rate. The possibility that a driver is required to drive a vehicle under severe conditions as described above sometimes gives the driver mental pressure for provided assist information.

### SUMMARY OF THE INVENTION

The present invention provides a driving assisting apparatus and a driving assisting method that helps a driver to drive smoothly while reducing driver's load.

A first aspect of the invention relates to a driving assisting apparatus that assists in driving a vehicle. The driving assisting apparatus includes: a vehicle speed sensor that detects a vehicle speed of the vehicle; a control unit that determines a recommended traveling state based on a current vehicle speed detected by the vehicle speed sensor and at least one of an accelerated vehicle speed when the vehicle accelerates from the current vehicle speed at an allowable acceleration and a decelerated vehicle speed when the vehicle decelerates from the current vehicle speed at an allowable deceleration; and an assisting unit that assists in driving the vehicle based on the recommended traveling state determined by the control unit.

The control unit may determine the recommended traveling state based on at least one of a vehicle speed range from the current vehicle speed to the accelerated vehicle speed and a vehicle speed range from the decelerated vehicle speed to the current vehicle speed.

The assisting unit may notify about the recommended traveling state.

The driving assisting apparatus may further comprising a communication unit that acquires traffic light information about a change in display state of a traffic light installed ahead in a traveling direction of the vehicle, and a position detection unit that detects relative position information between the vehicle and a traffic light location at which the traffic light is installed. The control unit may determine the recommended traveling state based on the relative position information detected by the position detection unit and the traffic light information acquired by the communication unit.

The control unit may changes at least one of the allowable acceleration and the allowable deceleration according to a light color displayed by the traffic light.

The control unit may estimate a normal arrival time, at which the vehicle arrives at the traffic light location when the vehicle travels at the current vehicle speed, and an accelerated arrival time at which the vehicle arrives at the traffic light location when the vehicle accelerates from the current vehicle speed at the allowable acceleration, and, if a passable display period, during which the traffic light permits the vehicle to pass through, is included in a first period from the accelerated arrival time to the normal arrival time, the control unit may determine the recommended traveling state based on a passable vehicle speed range that is a vehicle speed range at which the vehicle is permitted to pass through the traffic light location.

The control unit may set a vehicle speed range required to pass through the traffic light location during a period in which the passable display period overlaps with the first period to the passable vehicle speed range.

The control unit may set a vehicle speed at the accelerated arrival time to an upper-limit speed of the passable vehicle speed range.

The control unit may estimate a normal arrival time, at which the vehicle arrives at the traffic light location when the vehicle travels at the current vehicle speed, and a decelerated arrival time at which the vehicle arrives at the traffic light location when the vehicle decelerates from the current vehicle speed at the allowable deceleration, and, if a passable display period, during which the traffic light permits the vehicle to pass through, is included in a second period from the normal arrival time to the decelerated arrival time, the control unit may determine the recommended traveling state based on a passable vehicle speed range that is a vehicle speed range at which the vehicle is permitted to pass through the traffic light location.

The control unit may set a vehicle speed range required to pass through the traffic light location during a period in which the passable display period overlaps with the second period to the passable vehicle speed range.

The control unit may set a vehicle speed at the decelerated arrival time to a lower-limit speed of the passable vehicle speed range.

The assisting unit may notify about a target vehicle speed range as the recommended traveling state, and the control unit may set the passable vehicle speed range to the target vehicle speed range.

The control unit may acquire information about a vehicle speed limit and determine the recommended traveling state such that a vehicle speed corresponding to the recommended traveling state does not exceed the vehicle speed limit.

The control unit may determine a target vehicle speed range as the recommended traveling state.

The assisting unit may notify about the target vehicle speed range.

A second aspect of the invention relates to a driving assisting method for assisting in driving a vehicle. The driving assisting method includes: detecting a vehicle speed of the vehicle; determining a recommended traveling state based on the detected current vehicle speed and at least one of an accelerated vehicle speed when the vehicle accelerates from the current vehicle speed at an allowable acceleration and a decelerated vehicle speed when the vehicle decelerates from the current vehicle speed at an allowable deceleration; and assisting in driving the vehicle based on the recommended traveling state.

According to the configurations described above, the driving assisting apparatus assists a driver to drive smoothly while reducing driver's load.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing an example of a driving assisting system in this embodiment;

FIG. 2 is a block diagram showing the general configuration of a vehicle in which a driving assisting apparatus in this embodiment is mounted;

FIG. 3 is a diagram schematically showing an example of a speed display area of a display device;

FIG. 4 is a flowchart showing an example of the processing of the driving assisting apparatus;

FIG. 5 is a diagram showing an example of the processing of the driving assisting apparatus;

FIG. 6 is a diagram schematically showing an example of the speed display area of the display device;

FIG. 7 is a diagram schematically showing an example of the speed display area of the display device;

FIG. 8 is a diagram showing an example of the processing of the driving assisting apparatus;

FIG. 9 is a diagram showing an example of the processing of the driving assisting apparatus;

FIG. 10 is a diagram showing an example of the processing of the driving assisting apparatus;

FIG. 11 is a flowchart showing another example of the processing of the driving assisting apparatus; and

FIG. 12 is a diagram showing an example of the processing of the driving assisting apparatus.

### DETAILED DESCRIPTION OF EMBODIMENTS

The following describes a driving assisting apparatus in an embodiment of the present invention in detail with reference to the drawings. It should be noted that the present invention is not limited by this embodiment. It should also be noted that the components in the embodiment described below include components easily understood by those skilled in the art or components substantially equivalent to those components.

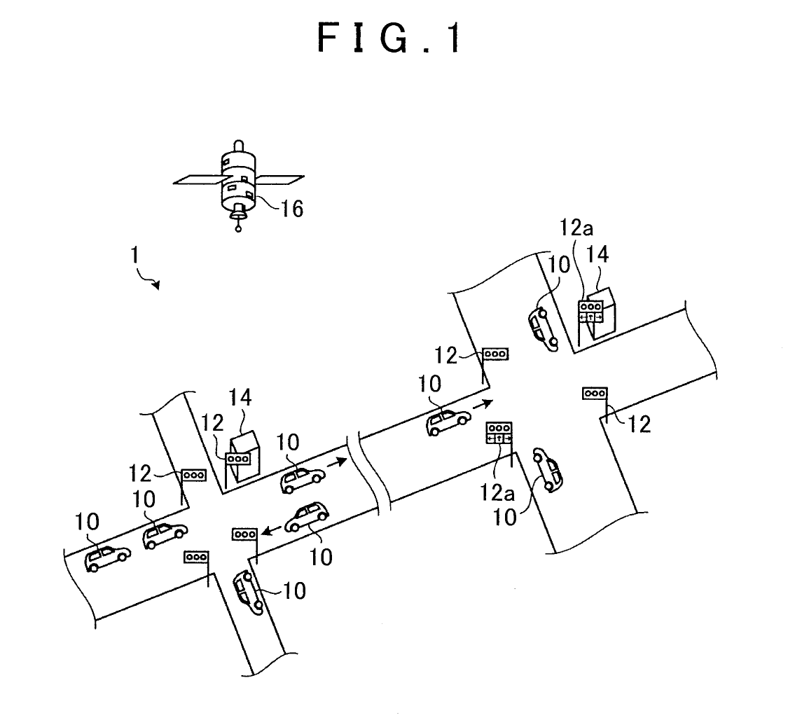

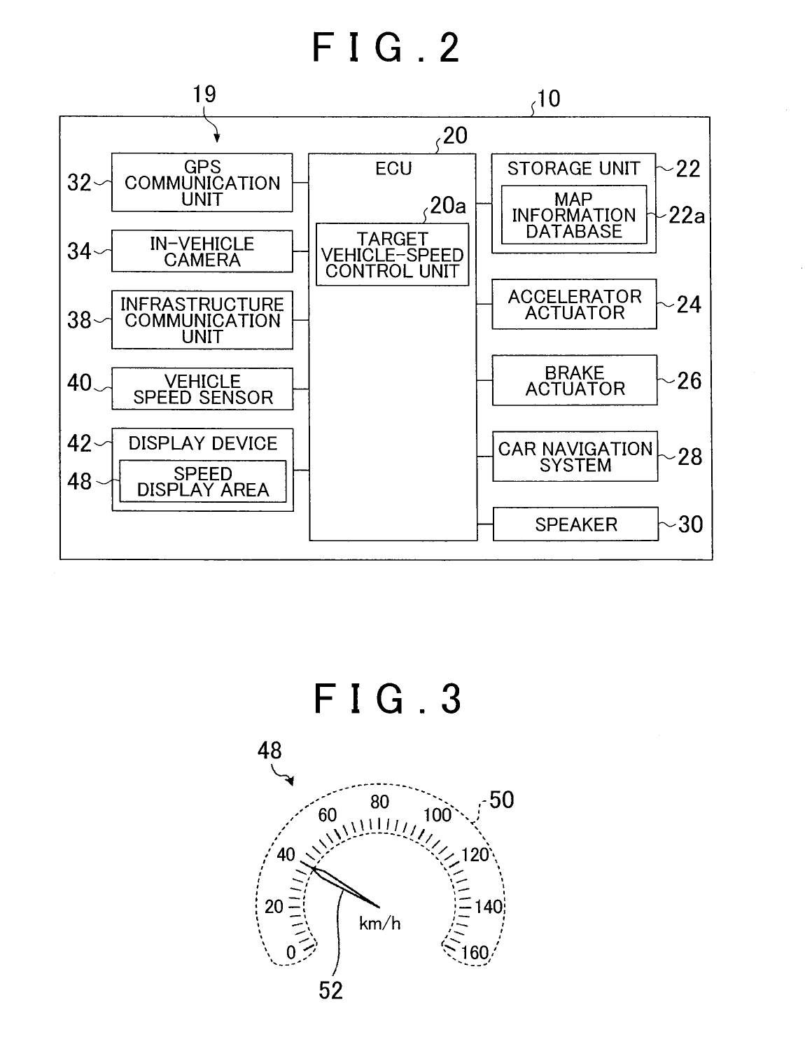

The embodiment is described with reference to FIG. 1 to FIG. 7. This embodiment relates to a driving assisting system including a vehicle in which a driving assisting apparatus is mounted. First, with reference to FIG. 1 to FIG. 3, the following describes the configuration of the driving assisting system including a vehicle in which the driving assisting apparatus is mounted. FIG. 1 is a diagram showing an example of the driving assisting system in this embodiment. FIG. 2 is a block diagram showing the general configuration of a vehicle in which the driving assisting apparatus in this embodiment is mounted. FIG. 3 is a diagram schematically showing an example of the speed display area of a display device.

A driving assisting system 1 shown in FIG. 1 includes multiple vehicles 10, multiple traffic lights 12 and 12a, multiple infrastructure information transmission devices 14. and a GPS satellite 16. The driving assisting system 1 is a system that assists a driver in driving the vehicle 10, which is one of the multiple vehicles 10 and in which a driving assisting apparatus 19 described later is mounted, based on the driving assist information. The driving assist information is information obtained by detecting the relation between the vehicle 10, in which the driving assisting apparatus 19 is mounted, and another vehicle 10 or by acquiring information from the infrastructure information transmission device 14 and the GPS satellite 16.

The vehicle 10 is an vehicle that can travel on a road, for example, an automobile and truck. The vehicle 10 can travel on a road on which the traffic lights 12 and 12a are installed. The configuration of the vehicle 10 is described later.

The traffic lights 12 and 12a are light devices installed at an intersection. The traffic light 12 includes light units in three colors, namely green, yellow, and red. The traffic light 12a includes the light unit in three-colors as well as a light unit (arrow light unit) that displays arrows. The traffic lights 12 and 12a are installed in the vehicle traveling directions along a road, one for each direction. The traffic light 12 switches an illuminated light unit, from among the light unit in three colors, to indicate whether the vehicle 10 may pass the corresponding road in the traveling direction of the vehicle 10 or the vehicle 10 may not pass the corresponding road in the traveling direction of the vehicle 10 (that is, the vehicle must stop). The traffic lights 12 and 12a, though installed at an intersection in the driving assisting system 1 shown in FIG. 1, may be installed at a location other than an intersection. For example, the traffic lights 12 and 12a may be installed at a pedestrian crossing. In FIG. 1, the traffic lights 12 and 12a are shown in such a way that the display of all light units can be seen. On an actual road, however, the traffic lights 12 and 12a are installed with their faces directed toward the vehicle 10 that is traveling toward the light units (vehicle passing through the traffic lights 12 and 12a).

The infrastructure information transmission device 14 transmits the road information on a road on which the vehicle 10 travels and the infrastructure information such as the traffic light information on the traffic lights 12 and 12a ahead in the traveling direction of the vehicle 10. The infrastructure information transmission device 14 in this embodiment, located at each intersection, transmits infrastructure information wirelessly to the vehicles 10 traveling in a predetermined range of the surrounding area. Typically, the road information includes the vehicle speed limit information on a road on which the vehicle 10 travels, the stop-line position information at an intersection, and so on. Typically, the traffic light information includes the traffic light cycle information such as the lighting cycle of the green light, yellow light, and red light of the traffic lights 12 and 12a, a traffic light change time, and so on. The infrastructure information transmission device 14 may be installed one for each of the traffic lights 12 and 12a or one for multiple intersections.

The GPS satellite 16 is a satellite that outputs the GPS signal necessary for detecting a position by Global Positioning System (GPS). Although only one GPS satellite 16 is shown in FIG. 1, the driving assisting system 1 includes at least three GPS satellites 16. A device that detects its position via GPS receives the GPS signals output from at least three GPS satellites 16 and compares the received GPS signals to detect the position of the device itself.

Next, with reference to FIG. 2, the following describes the vehicle 10 in which the driving assisting apparatus 19 is mounted. Although it is assumed that the driving assisting apparatus 19 is installed in all vehicles 10 in the driving assisting system 1 shown in FIG. 1, it is only required that the driving assisting apparatus 19 is mounted in at least one vehicle 10. That is, in the driving assisting system 1, a vehicle in which the driving assisting apparatus 19 is not mounted may travel before or after the vehicle 10 in which the driving assisting apparatus 19 is mounted.

The vehicle 10 includes an electronic control unit (ECU) 20, a storage unit 22, an accelerator actuator 24, a brake actuator 26, a car navigation system 28, a speaker 30, a GPS communication unit 32, an in-vehicle camera 34, an infrastructure communication unit 38, a vehicle speed sensor 40, and a display device 42. The ECU 20, storage unit 22, accelerator actuator 24, brake actuator 26, car navigation system 28, speaker 30, GPS communication unit 32, in-vehicle camera 34, infrastructure communication unit 38, vehicle speed sensor 40, and display device 42 configure the driving assisting apparatus 19 of the vehicle 10. In addition to the components described above, the vehicle 10 includes components generally included in a vehicle, such as the vehicle body, a driving source, brake system, and operation unit (for example, steering wheel, accelerator pedal, brake pedal), and so on.

The ECU 20 controls the components of the vehicle 10 such as the accelerator actuator 24, brake actuator 26, car navigation system 28, speaker 30, GPS communication unit 32, in-vehicle camera 34, infrastructure communication unit 38, vehicle speed sensor 40, and display device 42. The ECU 20 controls the operation of the components based on the information acquired by the GPS communication unit 32, in-vehicle camera 34, infrastructure communication unit 38, and vehicle speed sensor 40 and on the driver's operations received from various operation units such as the accelerator pedal and brake pedal not shown. The ECU 20 includes a target vehicle-speed control unit (control unit) 20a. The target vehicle-speed control unit 20a is described later.

The storage unit 22 is a storage device such as a memory. The storage unit 22 stores conditions and data required for various types of processing of the ECU 20 and various programs executed by the ECU 20. In addition, the storage unit 22 stores a map information database 22a. The map information database 22a stores information required for the traveling of a vehicle (map, straight road, curve, upslope and downslope, highway, sag zone, and tunnel). The map information database 22a includes a map data file, an intersection data file, a node data file, and a road data file. The ECU 20 references the map information database 22a to read necessary information.

The accelerator actuator 24 controls the output of the power source of the vehicle 10 such as the engine or the motor. For example, the accelerator actuator 24 controls the engine intake air amount, intake time and ignition time. voltage value and frequency of electric power supplied to the motor. The accelerator actuator 24, electrically connected to the ECU 20, has its operation controlled by the ECU 20. The ECU 20 activates the accelerator actuator 24 according to the accelerator control signal to adjust the engine intake air amount, intake time and ignition time, voltage value and frequency of electric power supplied to the motor. In other words. the accelerator actuator 24 is a device for automatically controlling the driving power generated by the power source. The accelerator actuator 24 receives the accelerator control signal from the ECU 20 and controls the components to control the driving condition and to generate a desired driving power. In this manner, the accelerator actuator 24 controls the driving power, applied to the vehicle 10, to adjust the acceleration.

The brake actuator 26 controls the driving of the brake system mounted in the vehicle 10. For example, the brake actuator 26 controls the hydraulic pressure of the wheel cylinder provided in the brake system. The brake actuator 26, electrically connected to the ECU 20, has its operation controlled by the ECU 20. The ECU 20 activates the brake actuator 26 according to the brake control signal and adjusts the brake hydraulic pressure of the wheel cylinder. In other words, the brake actuator 26 is a device for automatically controlling the braking force generated by the brake. The brake actuator 26 receives the brake control signal from the ECU 20 and drives the solenoid and the motor of the mechanism that supplies hydraulic oil to the wheel cylinder to control the brake hydraulic pressure and to generate a desired braking power. In this manner, the brake actuator 26 controls the braking power, applied to the vehicle 10, to adjust the deceleration.

The car navigation system 28 is a system that guides the vehicle 10 to a desired destination. The car navigation system 28 is capable of two-way communication with the ECU 20. The car navigation system 28 includes a display unit on which the map information on the surrounding area is displayed based on the information stored in the map information database 22a or the current position information acquired by the GPS communication unit 32 described later. The car navigation system 28 detects a route to the destination, based on the information stored in the map information database 22a, the information on the current position acquired by the GPS communication unit 32 described later, and the information on the destination entered by a driver, and displays the detected route information on the display unit. The car navigation system 28 may include in itself a map information database and a GPS communication unit separately from the map information database 22a and the GPS communication unit 32. In this case, the car navigation system 28 may be configured to perform route guidance and current position information notification using its own components.

The speaker 30 outputs voice in the vehicle 10. The speaker 30 outputs a voice, corresponding to a voice signal sent from the ECU 20, in the vehicle.

The GPS communication unit 32 receives the GPS signals output respectively from multiple GPS satellites 16. The GPS communication unit 32 sends the received GPS signals to the ECU 20. The ECU 20 analyzes the multiple received GPS signals to detect the position information on itself.

The in-vehicle camera 34 is an imaging device installed on the front side of the vehicle 10. The in-vehicle camera 34 acquires the image of an object in front of the vehicle 10 (ahead in the direction of traveling). The in-vehicle camera 34 sends the acquired image of the front of the vehicle 10 to the ECU 20. The ECU 20 analyzes the image, acquired by the in-vehicle camera 34, to acquire information on the state in front of the vehicle 10, that is, information whether another vehicle 10 is ahead of the vehicle, whether the vehicle is approaching the traffic light 12 or 12a, or whether the vehicle is approaching an intersection.

The infrastructure communication unit 38 wirelessly communicates with the infrastructure information transmission device 14 described above. The infrastructure communication unit 38 acquires infrastructure information, sent from the infrastructure information transmission device 14, and sends the acquired infrastructure information to the ECU 20. The infrastructure communication unit 38 may acquire infrastructure information by continuously communicating with the infrastructure information transmission device 14 ready for communication. by communicating with the infrastructure information transmission device 14 at regular intervals, or by communicating with the new infrastructure information transmission device 14 that becomes ready for communication.

The vehicle speed sensor 40 detects the vehicle speed of the vehicle 10. The vehicle speed sensor 40 sends the detected vehicle speed information to the ECU 20.

The display device 42 is a display device that displays various types of information to be notified to a driver. The display device 42 is, for example, an instrument panel provided on the dashboard of the vehicle 10. The display device 42 may be a liquid crystal display device or a display device on which various instruments are arranged. The display device 42 displays information on amount of fuel remaining in the vehicle, the output of the driving source (engine revolution speed), the door open/close state, and the seat belt wearing state. The display device 42 includes a speed display area 48 in which the vehicle speed is displayed.

As shown in FIG. 3, the speed display area 48 includes a scale display unit 50 and a pointer 52. The arc-shaped scale display unit 50 has the scale in the range 0 km/h to 160 km/h. The pointer 52, which indicates the result of a detected vehicle speed, points to 40 km/h in FIG. 3. The speed display area 48 is an analog meter with the position of the pointer 52 changed according to the current vehicle speed. The driver confirms the position, pointed to by the pointer 52 in the speed display area 48, to recognize the detection result of the current vehicle speed.

Next, the following describes the control operation performed by the target vehicle-speed control unit 20a of the ECU 20. The target vehicle-speed control unit 20a determines whether the vehicle 10 is permitted to pass through a target traffic light location (a region through which the vehicle 10 will pass, i.e., an intersection or a pedestrian crossing at which the traffic light 12 or 12a is located) based on the information acquired by the components of the vehicle 10. If it is determined that the vehicle 10 is permitted to pass through the target traffic light location, the target vehicle-speed control unit 20a determines a range of vehicle speed, at which the vehicle is permitted to pass through the traffic light location, as a target vehicle speed range and displays the determined target vehicle speed range in the speed display area 48 on the display device 42. More specifically, the target vehicle-speed control unit 20a determines whether the vehicle 10 is able to pass through the traffic light location within a predetermined period (without stopping before the traffic light location), based on the traffic light cycle information acquired by the infrastructure communication unit 38, the distance between the vehicle 10 and the traffic light 12 or 12a, the current vehicle-speed information detected by the vehicle speed sensor 40, and the preset allowable acceleration and the preset allowable deceleration that are set. In this case, the traffic light cycle information is traffic light information about the change in the display state of the traffic light 12 or 12a. The traffic light cycle information includes the lighting cycle or the traffic light change time of the traffic light 12 or 12a installed at the traffic light location. More precisely, the distance between the vehicle 10 and the traffic light 12 or 12a is the distance to the traffic location at which the traffic light 12 or 12a is located. The predetermined period is a period during which the traffic light 12, or 12a is in a display state (passable display state) indicating that the traffic light permits the vehicle 10 to pass. If it is determined that the vehicle 10 is permitted to pass through the target traffic light location, the target vehicle-speed control unit 20a calculates a range of traveling speed (as a target vehicle speed range) required for the vehicle 10 to pass through the traffic light location while the traffic light 12 or 12a is in the passable display state. The target vehicle speed range is a range of traveling speed recommended for the vehicle 10 to travel. The target vehicle-speed control unit 20a displays the calculated target vehicle speed range in the speed display area 48. In this manner, the target vehicle-speed control unit 20a performs the green wave assist. This green wave assist is a control in which the vehicle speed is notified to the driver to reduce the number of times the vehicle 10 will stop at a red light. The passable display state of the traffic light is the state in which the traffic light displays the traffic light indicating that the vehicle is permitted to pass through the target route. The passable display state of the traffic light is not limited to the state in which the green traffic light is displayed, but includes the state in which an arrow traffic light is displayed. The state in which the yellow traffic light is displayed may also be included in the passable display state.

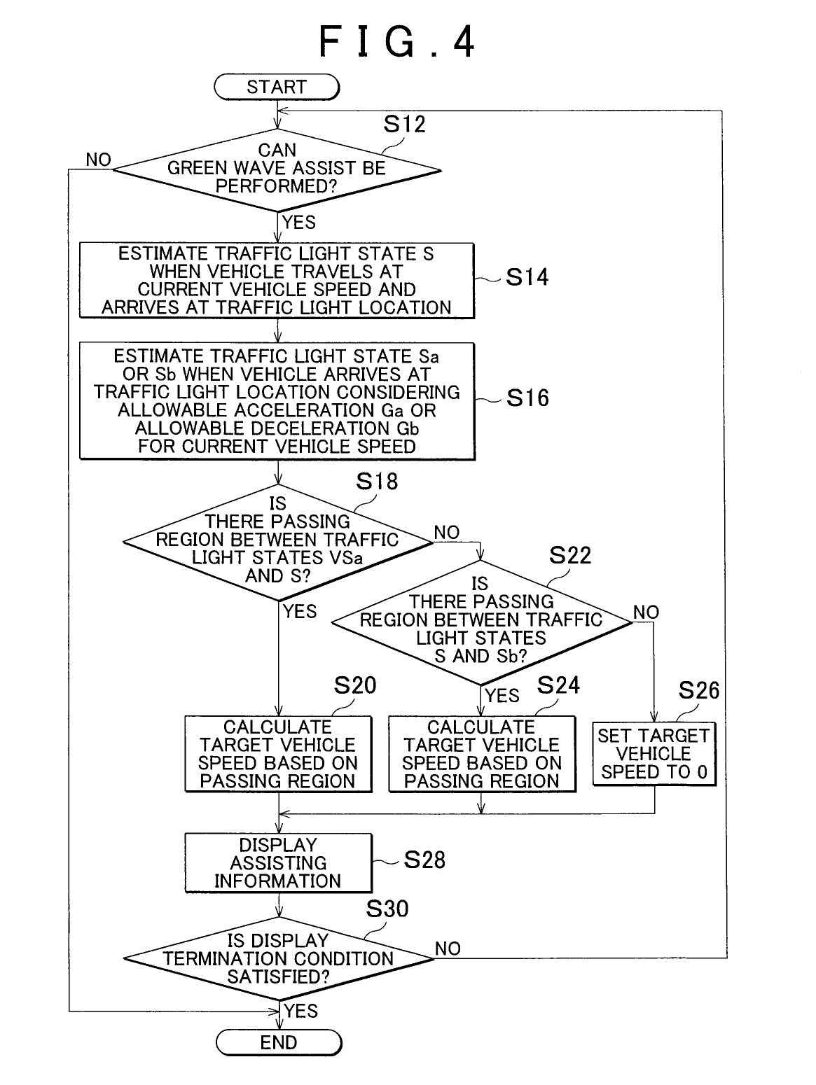

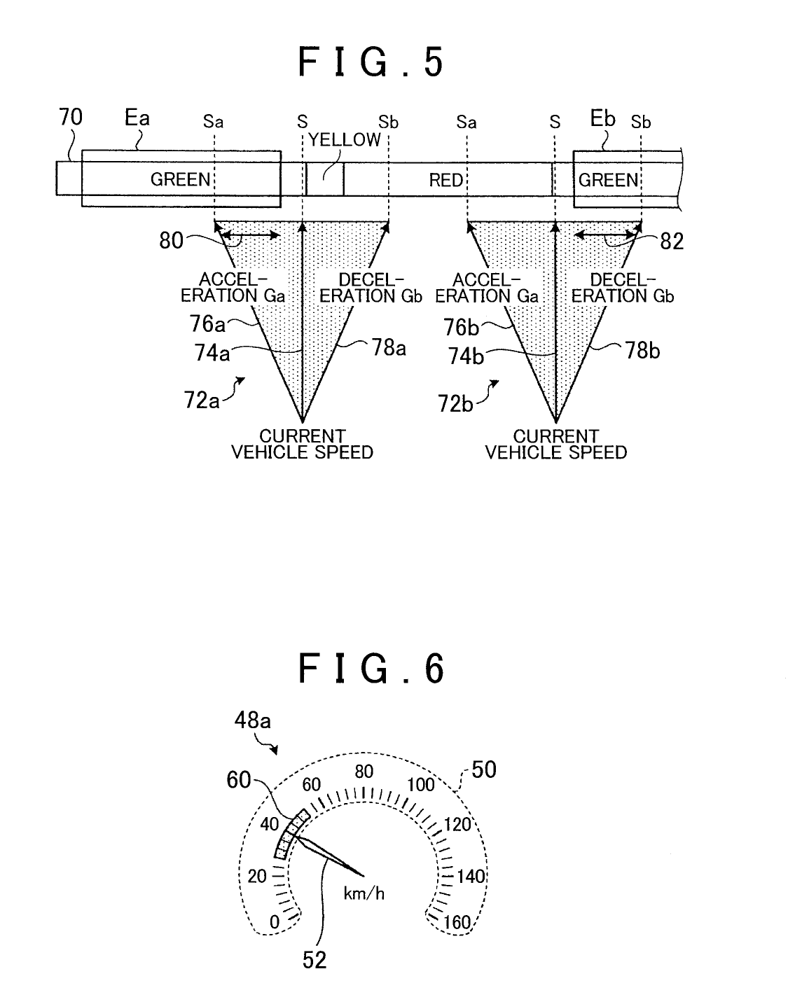

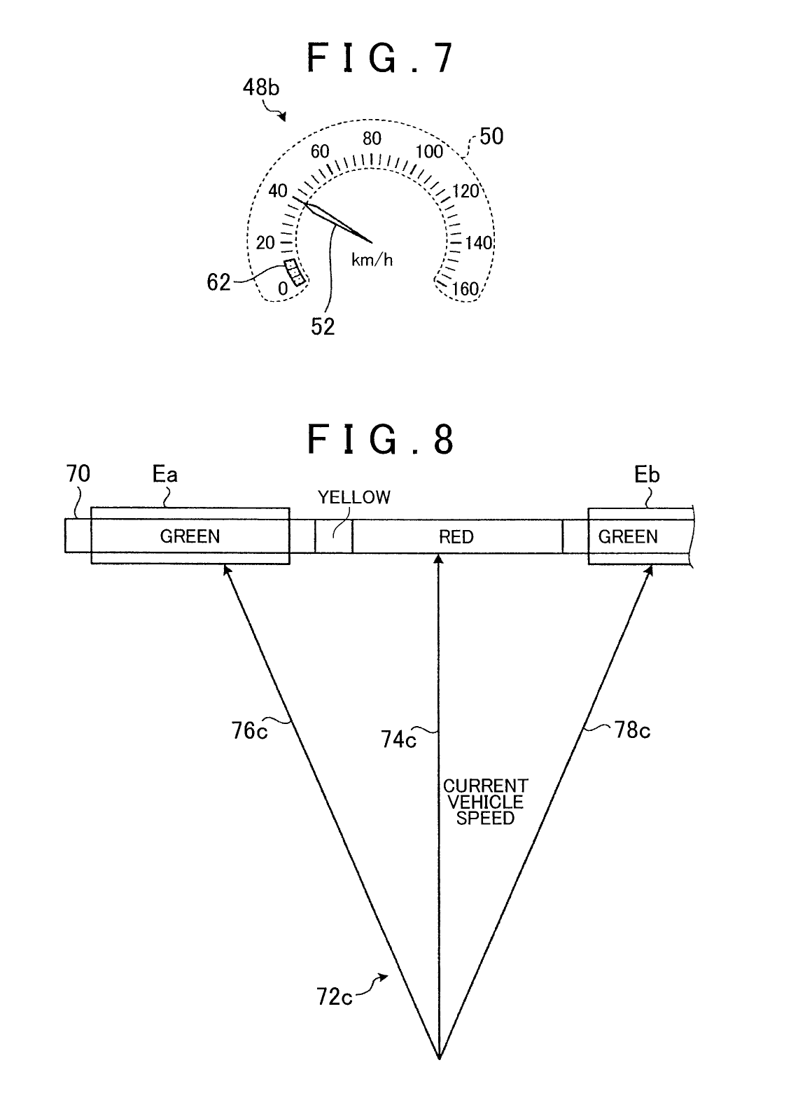

The following describes the control operation, performed by the target vehicle-speed control unit 20a of the ECU 20 in the vehicle 10, more in detail with reference to FIG. 4 to FIG. 7. FIG. 4 is a flowchart showing an example of the processing of the driving assisting apparatus. FIG. 5 is a diagram showing an example of the processing of the driving assisting apparatus. FIG. 6 and FIG. 7 are diagrams schematically showing an example of the speed display area of the display device.

In step S12, the target vehicle-speed control unit 20a of the ECU 20 determines whether the green wave assist can be performed. More specifically, the target vehicle-speed control unit 20a determines whether the information required for calculating the target vehicle speed range is acquired and whether the condition for displaying the target vehicle speed range is satisfied. The information required for calculating the target vehicle speed range includes the infrastructure information including the lighting cycle and the traffic light change time of the traffic light 12 or 12a through which the vehicle 10 will pass, the information on the current position of the vehicle 10 required for calculating the distance between the vehicle 10 and the traffic light 12 or 12a, and the map information including the position information on the traffic light 12 or traffic light 12a. The condition for displaying the target vehicle speed range is that the distance between the vehicle 10 and the traffic light 12 or traffic light 12a (distance between the vehicle 10 and the traffic light location) is a predetermined distance or longer and that the current vehicle speed of the vehicle 10 is a predetermined speed or higher, for example. If the distance between the vehicle 10 and the traffic light location is shorter than a predetermined distance, the target vehicle-speed control unit 20a determines that the green wave assist cannot be performed because, even if a target vehicle speed range is displayed, it is difficult for the driver to drive the vehicle according to the target vehicle speed range. If the current vehicle speed of the vehicle 10 is lower than a predetermined speed, it is likely that the traveling road is congested and the traveling speed of the vehicle 10 is limited or that the vehicle 10 is going to stop or has stopped for some reason. Therefore, if the current vehicle speed of the vehicle 10 is lower than a predetermined speed, the target vehicle-speed control unit 20a determines that the green wave assist cannot be performed because, even if a target vehicle speed range is displayed, it is difficult for the driver to drive the vehicle according to the target vehicle speed range. If it is determined in step S12 that the green wave assist cannot be performed (No in step S12), the target vehicle-speed control unit 20a terminates the processing.

If it is determined in step S12 that the green wave assist can be performed (Yes in step S12), the target vehicle-speed control unit 20a estimates, in step S14, the traffic light state S at a time when the vehicle 10 travels at the current vehicle speed and arrives at the traffic light location. More specifically, the target vehicle-speed control unit 20a estimates the time (normal arrival time) at which the vehicle 10 will arrive at the traffic light location based on the distance between the vehicle 10 and the traffic light location and on the current vehicle speed. After that, based on the estimated normal arrival time and the traffic light cycle information, the target vehicle-speed control unit 20a estimates the traffic light state at the normal arrival time as the traffic light state S. In the description below, the traffic light state S includes the following three: the traffic light color when the vehicle 10 arrives at the traffic light location, the display duration of the displayed traffic light color (time elapsed from the start of display), and the time remaining until the displayed traffic light color changes to the next traffic light color (remaining traffic-light display time).

After the traffic light state S at the normal arrival time is estimated in step S14, the target vehicle-speed control unit 20a estimates, in step S16, the traffic light state Sa or Sb at a time when the vehicle 10 arrives at the traffic light location, considering a predetermined acceleration (allowable acceleration) Ga or a predetermined deceleration (allowable deceleration) Gb, respectively. First, the following describes how the traffic light state Sa at the traffic light location arrival time is estimated when the allowable acceleration Ga is taken into consideration. The target vehicle-speed control unit 20a estimates the time (accelerated arrival time) at which the vehicle 10 will arrive at the traffic light location when the vehicle 10 accelerates from the current vehicle speed at the allowable acceleration Ga. based on the distance between the vehicle 10 and the traffic light location, the current vehicle speed, and the allowable acceleration Ga. Then, based on the estimated accelerated arrival time and the traffic light cycle information, the target vehicle-speed control unit 20a estimates the traffic light state at the accelerated arrival time as the traffic light state Sa. Next, the following describes how the traffic light state Sb at the traffic light location arrival time is estimated when the allowable deceleration Gb is taken into consideration. The target vehicle-speed control unit 20a estimates the time (decelerated arrival time) at which the vehicle 10 will arrive at the traffic light location when the vehicle 10 decelerates from the current vehicle speed at the allowable deceleration Gb, based on the distance between the vehicle 10 and the traffic light location, the current vehicle speed, and the allowable deceleration Gb. Then, based on the estimated decelerated arrival time and the traffic light cycle information, the target vehicle-speed control unit 20a estimates the traffic light state at the decelerated arrival time as the traffic light state Sb. Note that the allowable acceleration Ga and the allowable deceleration Gb are set in advance.

After the traffic light state Sa and the traffic light state Sb are estimated in step S16, the target vehicle-speed control unit 20a determines, in step S18, whether there is a passing region in the traffic light state between traffic light state Sa and traffic light state S. The traffic light state between traffic light state Sa and the traffic light state S refers to the traffic light state after the traffic light state Sa and before the traffic light state S. The traffic light state after the traffic light state Sa and before the traffic light state S refers to the traffic light state in the time zone from the accelerated arrival time to the normal arrival time. The passing region refers to region in which the traffic light state is the green-light state (passable display state). That is, the target vehicle-speed control unit 20a determines whether there is a time zone, in which the color of the traffic light is green, in the traffic light state after the traffic light state Sa and before the traffic light state S.

If it is determined in step S18 that there is a passing region in the traffic light state between the traffic light state Sa and the traffic light state S (Yes in step S18), the target vehicle-speed control unit 20a calculates the target vehicle speed based on the passing region in step S20. That is, the target vehicle-speed control unit 20a calculates the vehicle speed (vehicle speed range), at which the vehicle 10 would pass through the traffic light location while the traffic light state is in the passing region, as the target vehicle speed (target vehicle speed range) and proceeds to step S28.

If it is determined in step S18 that there is no passing region in the traffic light state between the traffic light state Sa and the traffic light state S (No in step S18), the target vehicle-speed control unit 20a determines in step S22 whether there is a passing region in the traffic light state between the traffic light state S and the traffic light state Sb. The traffic light state between the traffic light state S and the traffic light state Sb refers to the traffic light state after the traffic light state S and before the traffic light state Sb. The traffic light state after the traffic light state S and before the traffic light state Sb refers to the traffic light state in the time zone from the normal arrival time to the decelerated arrival time. That is, the target vehicle-speed control unit 20a determines whether there is a time zone, in which the color of the traffic light is green, in the traffic light state after the traffic light state S and before the traffic light state Sb.

If it is determined in step S22 that there is a passing region in the traffic light state between the traffic light state S and the traffic light state Sb (Yes in step S22), the target vehicle-speed control unit 20a calculates the target vehicle speed based on the passing region in step S24. That is, the target vehicle-speed control unit 20a calculates the vehicle speed range (vehicle speed), at which the vehicle 10 would pass through the traffic light location while the traffic light state is in the passing region, as the target vehicle speed range (target vehicle speed) and proceeds to step S28.

If it is determined in step S22 that there is no passing region in the traffic light state between the traffic light state S and the traffic light state Sb (No in step S22), the target vehicle-speed control unit 20a sets the target vehicle speed to 0 in step S26 and proceeds to step S28. That is, if it is determined that there is no passing region in the traffic light state from the traffic light state Sa to the traffic light state Sb, the target vehicle-speed control unit 20a sets the target vehicle speed to 0 to assist the vehicle to stop.

Now, with reference to FIG. 5, the following describes the relation between the processing shown in FIG. 4 and the traffic light colors displayed when the vehicle arrives at the traffic light location at estimated arrival times. The traffic light cycle 70 shown in FIG. 5 indicates the traffic light colors displayed at estimated arrival times. In the traffic light cycle 70, the traffic light color changes from green to yellow, from yellow to red, and then from red to green. Each of passing regions Ea and Eb in the traffic light cycle 70 is a time region satisfying the following three: the traffic light color is green, the time remained for the traffic light color to change from green to red is a predetermined time or longer, and the time elapsed from the time the traffic light color has changed to green is a predetermine time or longer. That is, the target vehicle-speed control unit 20a sets a time zone, in which the traffic light color is green and from which a predetermined initial time and a predetermined last time are excluded, as the passing regions Ea and Eb. The traffic light cycle 70 proceeds from left to right over time. Because FIG. 5 schematically shows the relation between the processing in FIG. 4 and the traffic light colors at estimated arrival times, the time axis of the traffic light cycle 70 is not fixed.

Each of an estimated pattern 72a and an estimated pattern 72b shown in FIG. 5 is an estimated result of the time of arrival to the traffic light location in a case where estimation is performed at given respective points of time. In the estimated pattern 72a, an arrow 74a indicates the normal arrival time at which the vehicle, which travels at the current vehicle speed, would arrive at the traffic light location, and the traffic light state at the normal arrival time is the traffic light state S pointed to by the arrow 74a. An arrow 76a indicates the accelerated from arrival time at which the vehicle, which accelerates the current vehicle speed at the allowable acceleration Ga, would arrive at the traffic light location, and the traffic light state at the accelerated arrival time is the traffic light state Sa pointed to by the arrow 76a. In addition, an arrow 78a indicates the decelerated arrival time at which the vehicle, which decelerates from the current vehicle speed at the allowable deceleration Gb, would arrive at the traffic light location, and the traffic light state at the decelerated arrival time is the traffic light state Sb pointed to by the arrow 78a. Similarly, in the estimated pattern 72b, an arrow 74b indicates the normal arrival time at which the vehicle, which travels at the current vehicle speed, would arrive at the traffic light location, and the traffic light state at the normal arrival time is the traffic light state S pointed to by the arrow 74b. An arrow 76b indicates the accelerated arrival time at which the vehicle, which accelerates from the current vehicle speed at the allowable acceleration Ga, would arrive at the traffic light location, and the traffic light state at the accelerated arrival time is the traffic light state Sa pointed to by the arrow 76b. In addition, an arrow 78b indicates the decelerated arrival time at which the vehicle, which decelerates from the current vehicle speed at the allowable deceleration Gb, would arrive at the traffic light location, and the traffic light state at the decelerated arrival time is the traffic light state Sb pointed to by the arrow 78b.

The target vehicle-speed control unit 20a determines whether to pass through, or stop at, the traffic light location during the processing in steps S14, S16, S18, and S22 shown in FIG. 4. For example, if the target vehicle-speed control unit 20a determines whether to pass through, or stop at, the traffic light location upon obtaining the estimated pattern 72a, a part of a region 80 in the traffic light state from the traffic light state Sa to traffic light state S overlaps with the passing region Ea. Therefore, the target vehicle-speed control unit 20a determines “Yes” in step S18 to calculate the vehicle speed range, corresponding to the region 80, as the target vehicle speed range. If the target vehicle-speed control unit 20a determines whether to pass through, or stop at, the traffic light location upon obtaining the estimated pattern 72b, the traffic light state from the traffic light state Sa to traffic light state S does not overlap with any of the passing regions Ea and Eb but a part of a region 82 in the traffic light state from the traffic light state S to the traffic light state Sb overlaps with the passing region Eb. Therefore, the target vehicle-speed control unit 20a determines “No” in step S18, and “Yes” in step S22, to calculate the vehicle speed range, corresponding to the region 82, as the target vehicle speed range.

Returning to FIG. 4, the following continues the description of the flowchart. After performing the processing in steps S20, step S24, and step S26, the target vehicle-speed control unit 20a displays assist information in step S28. If the processing in step S20 or step S24 is performed, the target vehicle-speed control unit 20a displays the passing assist information as the assist information in step S28. If the processing in step S26 is performed, the target vehicle-speed control unit 20a displays the stop assist information as the assist information in step S28.

To display the passing assist information, the target vehicle-speed control unit 20a displays the range of the vehicle speed at which the vehicle 10 is permitted to pass through the target traffic light location, that is, the target vehicle speed range determined in step S20 or step S24, in the speed display area 48. For example, the target vehicle-speed control unit 20a displays a speed display area 48a shown in FIG. 6. In the speed display area 48a, the target vehicle-speed control unit 20a displays a marker 60 in the speed range that overlaps with the target vehicle speed range in the scale display unit 50. Because the target vehicle speed range is 30 km/h to 50 km/h in this embodiment, the marker 60 is displayed in the vehicle speed range from 30 km/h to 50 km/h. When the scale display unit 50 is displayed on a liquid crystal display device as an image, the speed display area 48a is displayed with the image of the marker 60 displayed on top of the image of the scale display unit 50. When the scale display unit 50 is drawn in ink, the speed display area 48a may be displayed by arranging light-emitting units on the scale part of the scale display unit 50 and by turning on the light-emitting unit, corresponding to the target vehicle speed range, as the marker 60. The target vehicle-speed control unit 20a displays a target vehicle speed range on top of the dial display unit 50 as the marker 60 in this manner to allow the user to recognize the target vehicle speed range. After performing the processing in step S28, the target vehicle-speed control unit 20a proceeds to step S30.

To display the stop assist information, the target vehicle-speed control unit 20a displays the target vehicle speed range, recommended for the vehicle to stop at the traffic light location, that is, the target vehicle speed range determined in step S26, in the speed display area 48. In this embodiment, the target vehicle-speed control unit 20a displays the vehicle speed range around 0 km/h as the target vehicle speed range according to the value set in step S26. For example, the target vehicle-speed control unit 20a displays a speed display area 48b shown in FIG. 7. In the speed display area 48b, a marker 62 is displayed in the speed range that overlaps with the target vehicle speed range on the scale display unit 50. Because the target vehicle speed range is a vehicle speed range around 0 km/h (a vehicle speed range including 0 km/h, or 0 km/h to 10 km/h in this embodiment), the marker 62 is displayed in the vehicle speed range around 0 km/h. The target vehicle-speed control unit 20a displays the target vehicle speed range on the scale display unit 50 as the marker 62 in this manner to allow the user to recognize the target vehicle speed range. In step S22, the target vehicle-speed control unit 20a allows the user to recognize that the user is recommended to stop the vehicle 10. After performing the processing shown in step S28, the target vehicle-speed control unit 20a proceeds to step S30.

After the processing in step S28 is performed, the target vehicle-speed control unit 20a determines in step S30 whether the display termination condition is satisfied. The display termination condition refers to a pre-set condition for terminating the display of the target vehicle speed range. The display termination condition is satisfied, for example, when the distance between the vehicle and the traffic light location becomes a predetermined value or smaller, when the vehicle speed is outside a predetermined range, or when a predetermined time has elapsed after the target vehicle speed range is displayed. If it is determined in step S30 that the display termination condition is not satisfied (No in step S30), the target vehicle-speed control unit 20a proceeds to step S12 to repeat the processing described above. That is, the target vehicle-speed control unit 20a recalculates a target vehicle speed range and redisplays the target vehicle speed range. If it is determined in step S30 that the display termination condition is satisfied (Yes in step S30), the target vehicle-speed control unit 20a terminates the processing.

The driving assisting apparatus 19 (and vehicle 10 or driving assisting system 1 that includes the driving assisting apparatus 19) determines whether to pass through, or stop at. a traffic light location as described above via the processing in steps S14, S16, S18, and S22 shown in FIG. 4. More specifically, when determining whether to pass through, or stop at, a traffic light location, the driving assisting apparatus 19 first estimates the traffic light states S (traffic light state when the vehicle travels at the current vehicle speed), Sa (traffic light state when the vehicle accelerates from the current speed at the allowable acceleration Ga), and Sb (traffic light state when the vehicle decelerates from the current speed at the allowable deceleration Gb) as shown in FIG. 5 to obtain the estimated patterns 72a and 72b. Then, the driving assisting apparatus 19 uses each of the estimated patterns 72a and 72b to estimate the traffic light state for the time that ranges from the earliest arrival time to the latest arrival time. The earliest arrival time, which is achieved by accelerating from the current speed at the allowable acceleration Ga, refers to the time for the vehicle to arrive at the traffic light location earliest under the specified condition. The latest arrival time, which is achieved by decelerating from the current speed at the allowable deceleration Gb, refers to the time for the vehicle to arrive at the traffic light location latest under the specified condition. In addition, the drive aiding apparatus 19 checks whether each of the estimated pattern 72a or 72b overlaps with the passing region Ea or Eb to determine whether the traffic light state when the vehicle 10 arrives at the traffic light location under the specified condition includes the green traffic light state.

By determining whether to pass through, or stop at, a traffic light location based on the processing shown in FIG. 4 and FIG. 5, the driving assisting apparatus 19 can assist the vehicle to pass through the traffic light location if the color of the traffic light is green when the vehicle arrives at the traffic light location by accelerating from the current vehicle speed at a predetermined acceleration (allowable acceleration Ga) or when the vehicle arrives at the traffic light location by decelerating from the current speed at a predetermined deceleration (allowable deceleration Gb). That is, the driving assisting apparatus 19 determines that the vehicle is not permitted to pass through the traffic light location if an excessive acceleration or deceleration is required for the current vehicle speed. Therefore, the driving assisting apparatus 19 does not notify the driver about a passing-assist target vehicle speed range that requires acceleration exceeding the allowable acceleration Ga or that requires deceleration exceeding the allowable deceleration Gb. Thus, the driving assisting apparatus 19 does not notify the driver about a target vehicle speed range that requires rapid acceleration or rapid deceleration but notifies the driver about a natural, stress-free target vehicle speed range. The driving assisting apparatus 19 enables the travel at a speed, included in a target vehicle speed range, in a moderate range of acceleration and deceleration and thus allows the driver to drive the vehicle 10 comfortably (a stop at a red traffic light is reduced in this embodiment) while maintaining an easy-to-drive state. However, to assist the driver to stop the vehicle, the driving assisting apparatus 19 sometimes gives guidance about a target vehicle speed range, which exceeds the allowable deceleration Gb, in order to stop the vehicle before the traffic light location.

If the vehicle is permitted to pass through a traffic light location at an acceleration or a deceleration in a predetermined range, the driving assisting apparatus 19 ideally assists the driver to pass through the traffic light location, thus giving the driver guidance about a more appropriate target vehicle speed range. In addition, the driving assisting apparatus 19 reduces the possibility that the driver feels that, if the current speed is accelerated or decelerated, the vehicle could pass through a traffic light location, thus giving driving assistance that reduces driver's distrust and suspicions.

The driving assisting apparatus 19 calculates a target vehicle speed range based on the relation between the estimated pattern 72a or estimated pattern 72b acquired as described above and the passing region Ea or Eb. That is, the driving assisting apparatus 19 calculates the target vehicle speed range based on the current vehicle speed, the predetermined acceleration, and the predetermined deceleration. That is, the driving assisting apparatus 19 does not calculate a vehicle speed range, in which an extreme acceleration or deceleration from the current vehicle speed is required, as the target vehicle speed range. Because of this, the driving assisting apparatus 19 reduces the possibility of providing a driver with guidance on a target vehicle speed range requiring rapid acceleration or deceleration and, as a result. provides the driver with guidance on a target vehicle speed range that is natural and stress-free. Because the vehicle can travel at a speed. included in a target vehicle speed range, in a moderate range of acceleration and deceleration, the driver can drive the vehicle 10 comfortably (a stop at a red traffic light is reduced in this embodiment) while maintaining an easy-to-drive state.

It is preferable that driving assisting apparatus 19 estimate the traffic light state for the two cases, that is, the case in which the vehicle accelerates from the current speed at the allowable acceleration Ga and the case in which the vehicle decelerates from the current speed at the allowable deceleration Gb, to obtain the estimated patterns, one for each, for use in determining whether to pass through, or stop at, the traffic light location. However, it is also possible to estimate only one of the traffic light states to obtain the estimated pattern. That is, the driving assisting apparatus 19 may estimate the traffic light state S when the vehicle travels at the current speed and the traffic light state Sa when the vehicle accelerates from the current speed at the allowable acceleration Ga and, based on the relation between the traffic light state from the traffic light state Sa to the traffic light state S and the passing region, determine whether to pass through, or stop at, the traffic light location. Similarly, the driving assisting apparatus 19 may estimate the traffic light state S when the vehicle travels at the current speed and the traffic light state Sb when the vehicle decelerates from the current speed at the allowable deceleration Gb and, based on the relation between the traffic light state from the traffic light state S to the traffic light state Sb and the passing region, determine whether to pass through, or stop at, the traffic light location.

FIG. 8 is a diagram showing an example of the processing of the driving assisting apparatus. The traffic light cycle 70 shown in FIG. 8 is the same as that shown in FIG. 5. The target vehicle-speed control unit 20a sets a time zone, in which the color of the traffic light is green and from which a predetermined initial time and a predetermined last time are excluded, as the passing regions Ea and Eb. An estimated pattern 72c shown in FIG. 8 is a result of the estimated times of arrival at a traffic light location generated by the determination as to whether to pass through, or stop at, the traffic light location at a given time. In the estimated pattern 72c, an arrow 74c indicates the normal arrival time when the vehicle travels at the current vehicle speed, an arrow 76c indicates the accelerated from arrival time when the vehicle accelerates the current vehicle speed at the allowable acceleration Ga. and an arrow 78c indicates the decelerated arrival time when the vehicle decelerates from the current vehicle speed at the allowable deceleration Gb.

When the driving assisting apparatus 19 determines whether to pass through, or stop at, a traffic light location using the estimated pattern 72c shown in FIG. 8, an overlap occurs between the traffic light state and a passing region in the following two cases: one is the case in which the traffic light state resulting when the vehicle accelerates from the current vehicle speed at the allowable acceleration Ga overlaps with the passing region Ea and the other is the case in which the traffic light state resulting when the vehicle decelerates from the current vehicle speed at the allowable deceleration Gb overlaps with the passing region Eb. According to the processing shown in FIG. 4, the traffic light state resulting when the vehicle accelerates from the current vehicle speed at the allowable acceleration Ga is compared with the passing region first. Therefore, according to the processing shown in FIG. 4, the driving assisting apparatus 19 first calculates a target vehicle speed range based on the region where the passing region Ea overlaps with the traffic light state resulting when the vehicle accelerates from the current vehicle speed at the allowable acceleration Ga. In this way, by first comparing the traffic light state resulting when the vehicle accelerates from the current vehicle speed at the allowable acceleration Ga with the passing region, the driving assisting apparatus 19 can give a driver the guidance on the target vehicle speed range that will allow the vehicle to pass through the traffic light location as soon as possible.

The driving assisting apparatus 19 may exchange the order of step S18 and step S22 in the processing shown in FIG. 4. In addition, the driving assisting apparatus 19 may determine the order of step S18 and step S22 in the processing shown in FIG. 4 based on various conditions. For example, the driving assisting apparatus 19 may use the in-vehicle camera 34 or a millimeter radar to determine whether there is another vehicle ahead of the host vehicle and exchange the order of the processing based on the result; that is, the driving assisting apparatus 19 may execute the processing in step S22 before the processing in step S18 if there is another vehicle close to and ahead of the host vehicle, and the processing in step S18 before the processing in step S22 if there is no such vehicle. The driving assisting apparatus 19 may also calculate the target vehicle speed range in both step S20 and step S24 and notify about a target vehicle speed range, whichever is closer to the current vehicle speed, to the driver. In addition, the driving assisting apparatus 19 may also notify about both target vehicle speed ranges, calculated in step S20 and step S24, to the driver.

As shown in FIG. 5, the driving assisting apparatus 19 sets each of the passing regions Ea and Eb as a region beginning at a predetermined time after the traffic light changes from the non-passable display state (for example, the color of the traffic light is red) to the passable display state (for example, color of the traffic light is green) and ending at a predetermined time before the traffic light changes from the passable display state to the non-passable display state. Then, the driving assisting apparatus 19 calculates a vehicle speed range, in which the vehicle is able to pass through the traffic light location during the passing region Ea or Eb, as the target vehicle speed range.

As described above, the driving assisting apparatus 19 determines the target vehicle speed range as a vehicle speed range in which the time remained until the color of the traffic light changes from green to red is equal to or longer than a predetermined time. Therefore, even if the vehicle speed is decelerated to a speed below the target vehicle speed range during actual traveling and, as a result, it takes longer to arrive at the traffic light location, the vehicle can pass through the traffic light location before the color of the traffic light changes to red. Similarly, the driving assisting apparatus 19 determines the target vehicle speed range as a vehicle speed range in which a predetermined time has elapsed from the time the color of the traffic light changes to green. Therefore, the color of the traffic light changes from red to green when the vehicle is at a location where the distance from the vehicle 10 to the traffic light location is long enough. Thus, the driving assisting apparatus 19 reduces the possibility that the vehicle is approaching a traffic light while the color of the traffic light is still red, reduces the driver's concern that the color of the traffic light will change and so the vehicle speed will have to be decelerated, and reduces the driver's discomfort.

It is preferable that the driving assisting apparatus 19 adjust and determine the above-described predetermined time, that is, the time that is included in the time zone in which the color of the traffic light is blue and that is not used for the calculation of a target vehicle speed range, according to the distance between the vehicle and the traffic light location. This allows the processing to be ideally performed according to the distance between the vehicle and the traffic light location.

It is preferable that the driving assisting apparatus 19 adjust and determine the above-described allowable acceleration Ga and the allowable deceleration Gb according to the distance between the vehicle and the traffic light location. Setting the allowable acceleration Ga and allowable deceleration Gb in this way allows the driving assisting apparatus 19 to change the criterion of whether to pass through, or stop at, a traffic light location more ideally according to the distance between the vehicle and the traffic light location, thereby making a better determination as to whether to pass through, or stop at, a traffic light location. More specifically, it is preferable that the longer the distance between the vehicle and the traffic light location is, the smaller the allowable acceleration Ga and the allowable deceleration Gb are and that the shorter the distance between the vehicle and the traffic light location is, the larger the allowable acceleration Ga and the allowable deceleration Gb are. Changing the criterion in this way reduces the possibility that the acceleration is so large that a target vehicle speed range, which cannot be achieved, is calculated.

It is also preferable that the driving assisting apparatus 19 adjust and determine the above-described allowable acceleration Ga and allowable deceleration Gb according to the current color of the traffic light. For example, when the current color of the traffic light is red, the driving assisting apparatus 19 may change the allowable acceleration Ga to a smaller value, and the allowable deceleration Gb to a larger value. Similarly, when the current color of the traffic light is green, the driving assisting apparatus 19 may change the allowable acceleration Ga to a larger value, and the allowable deceleration Gb to a smaller value. When the color of the traffic light in front of the vehicle is red, changing the allowable acceleration Ga and allowable deceleration Gb in this way makes it easy for an estimated pattern to overlap with a passing region that will be created when the traffic light becomes green next time. Therefore, the driving assisting apparatus 19 can more accurately calculate a speed at which the vehicle 10 is able to pass through the traffic light location without stopping. On the other hand, when the color of the traffic light in front of the vehicle is green, changing the allowable acceleration Ga and allowable deceleration Gb in this way makes it easy for an estimated pattern to overlap with a passing region that includes the green light that is currently displayed. Therefore, the driving assisting apparatus 19 can more accurately calculate a speed at which the vehicle 10 is able to pass through the traffic light location without stopping. An example of the basic value of the allowable acceleration Ga is 0.1 G, and an example of the criterion value of the allowable deceleration Gb is 0.3 G (−0.3 G).

Although the driving assisting apparatus 19 in this embodiment notifies about a target vehicle speed range, determined in step S26, to assist a driver to stop, the present invention is not limited to this method. The driving assisting apparatus 19, if unable to assist a driver to pass through a traffic light location, may not notify about a target vehicle speed range.

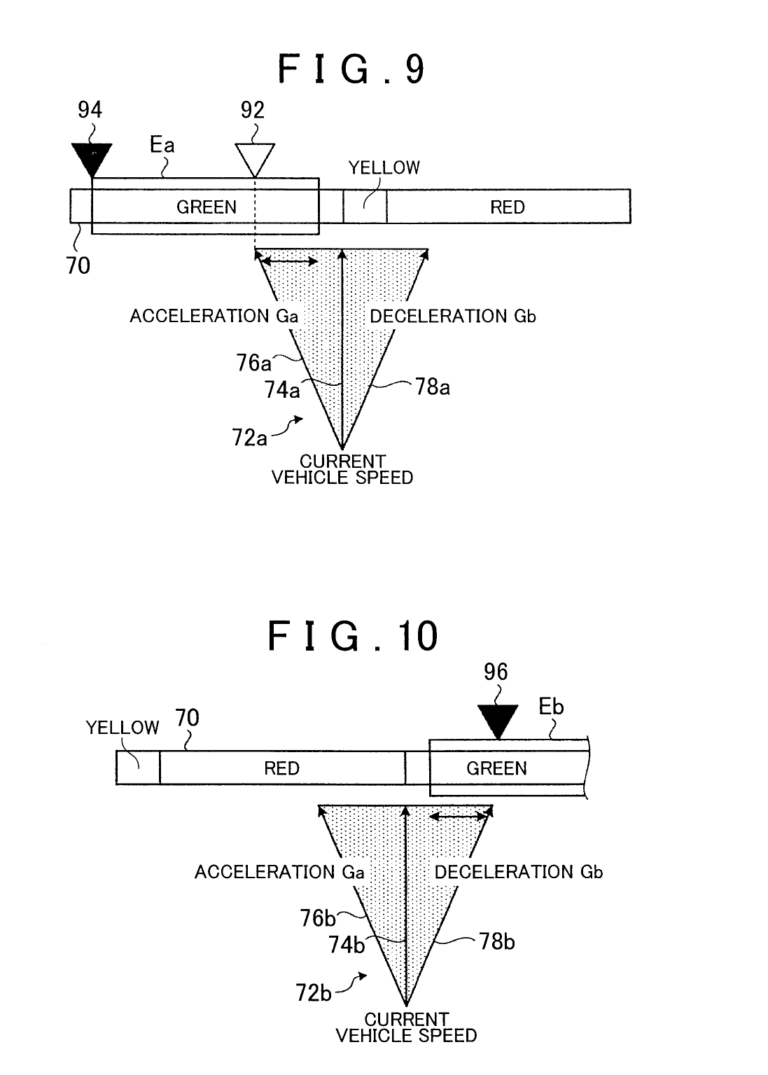

Although the driving assisting apparatus 19 in this embodiment calculates a target vehicle speed range based on a region where a traffic light state, ranging from the traffic light state when the vehicle accelerates to the traffic light state when the vehicle decelerates, overlaps with a passing region, the target vehicle speed range may be calculated based on any of the various criteria. FIG. 9 and FIG. 10 are diagrams each showing an example of the processing of the driving assisting apparatus. FIG. 9 is a diagram basically showing an enlarged version of the traffic light cycle 70 and the estimated pattern 72a shown in FIG. 5. According to the flowchart shown in FIG. 4, the driving assisting apparatus 19 sets the upper-limit speed of the target vehicle speed range based on the traffic light state at the time of a marker 92 pointed to by the arrow 76a, that is, based on the traffic light state Sa. This enables the speed, which is achieved by the allowable acceleration Ga, to be set as the upper-limit speed of the target vehicle speed range. In this case, the driving assisting apparatus 19 may also set the upper-limit speed of the target vehicle speed range based on the earliest time of the passing region Ea that overlaps with the estimated pattern 72a, that is, based on the traffic light state at the time of a marker 94. Because the upper-limit speed of the target vehicle speed range may become relatively large in this case, the threshold of the upper-limit speed may be set separately. The driving assisting apparatus 19 may use a speed, higher than the current vehicle speed by a predetermined speed α, as the upper-limit speed. By setting a speed, higher than the current vehicle speed by a predetermined speed α, as the upper-limit speed, the driving assisting apparatus 19 can prevent the acceleration, necessary for achieving the vehicle speed in the target vehicle speed range, from becoming too large. This allows the vehicle 10 and the driving assisting apparatus 19 to notify the driver about a target vehicle speed range that is less likely to give discomfort and stress to a driver.

The upper-limit speed of the target vehicle speed range is not limited to the upper-limit speed described above. The criterion speed for determining whether to assist the vehicle to pass through a traffic light location may also be set based on any of the various criteria in the same manner as that for the upper-limit speed of the target vehicle speed range is set.

FIG. 10 is a diagram basically showing an enlarged version of the traffic light cycle 70 and the pattern 72b shown in FIG. 5. According to the flowchart shown in FIG. 4, the driving assisting apparatus 19 sets the lower-limit speed of the target vehicle speed range based on the traffic light state at the time of a marker 96 pointed to by the arrow 78b, that is, based on the traffic light state Sb. This enables the speed, which is achieved by the allowable deceleration Gb, to be set as the lower-limit speed of the target vehicle speed range. In this case, the driving assisting apparatus 19 may also set the lower-limit speed of the target vehicle speed range based on the latest time of the passing region Eb that overlaps with the estimated pattern 72b. In this case, the lower-limit speed of the target vehicle speed range may become relatively small. Therefore, the threshold may also be set for the lower-limit speed separately as for the upper-limit speed.

Although the driving assisting apparatus 19 in the above embodiment sets the upper-limit speed of the target vehicle speed range all using the current vehicle speed, the upper-limit speed of the target vehicle speed range is not limited to the one that is set using the current vehicle speed. The driving assisting apparatus 19 may also use the vehicle speed limit of the road, on which the vehicle is traveling, as the upper-limit speed of the target vehicle speed range. In this case, the vehicle speed limit is, for example, the legal speed limit of the road on which the vehicle is traveling. The vehicle speed limit may be acquired from the infrastructure information acquired by the infrastructure communication unit 38 or may be acquired from the information stored in the map information database 22a based on the current position detected via the GPS signal received by the GPS communication unit 32. The driving assisting apparatus 19 may use a combination of the infrastructure communication unit 38 or the GPS communication unit 32 and the map information database 22a as an information acquisition unit for acquiring the vehicle speed limit information. The information acquisition unit for acquiring the vehicle speed limit information may use any other functional unit, for example, the in-vehicle camera 34, of the driving assisting apparatus 19. The driving assisting apparatus 19 may use the in-vehicle camera 34 to acquire the images of the road signs disposed on the traveling road and then acquire the legal speed limit, indicated by the image of the road signs, as the vehicle speed limit. By using the vehicle speed limit as the upper-limit speed of the target vehicle speed range, the driving assisting apparatus 19 can prevent the target vehicle speed range from exceeding the vehicle speed limit. This allows the driving assisting apparatus 19 to notify about a target vehicle speed range equal to or lower than the vehicle speed limit, to prevent a vehicle speed range, at which the vehicle is not actually permitted to travel, from being notified, and to notify a driver about a target vehicle speed range that is less likely to give discomfort and stress to the driver.

More preferably, the driving assisting apparatus 19 in the embodiment described above sets the upper-limit speed of a target vehicle speed range using both the current vehicle speed and the vehicle speed limit. That is, when the upper-limit speed of a target vehicle speed range is set using the current vehicle speed, it is preferable that the driving assisting apparatus 19 set the upper-limit speed such that the target vehicle speed range does not exceed the vehicle speed limit. Setting the upper-limit speed in this way allows the driving assisting apparatus 19 to achieve both effects described above and to notify a driver about a target vehicle speed range that is less likely to give discomfort and stress to the driver.

It is preferable that the driving assisting apparatus 19 display the marker 60 in the speed display area 48 using a color different between a target vehicle speed range for assisting the vehicle to pass and a target vehicle speed range for assisting the vehicle to stop. The driving assisting apparatus 19 may also display the marker 60 using not different colors but also different patterns or different lighting states. The marker 60, if displayed in this manner, enables a driver to quickly know which target vehicle speed range is displayed, a target vehicle speed range for assisting the vehicle to pass or a target vehicle speed range for assisting the vehicle to stop.

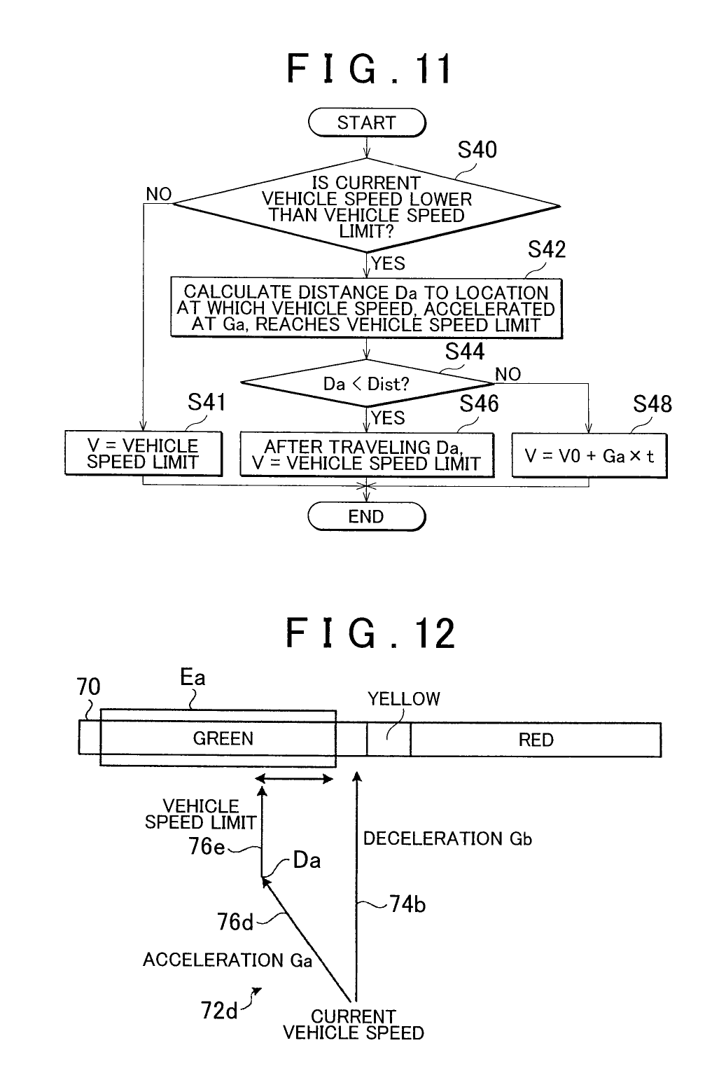

FIG. 11 is a flowchart showing another example of the processing of the driving assisting apparatus. FIG. 12 is a diagram showing an example of the processing of the driving assisting apparatus. It is preferable for the driving assisting apparatus in the above embodiment to consider the vehicle speed limit of a road on which the vehicle is traveling when acquiring an estimated pattern for determining whether to pass through, or stop at, a traffic light location. Note that the processing shown in FIG. 11 is executed as a part of the processing in step S16 shown in FIG. 4. The processing shown in FIG. 11 is performed to determine the vehicle speed condition (upper-limit vehicle speed V) used for estimating the traffic light state Sa.

As shown in FIG. 11, the target vehicle-speed control unit 20a of the driving assisting apparatus 19 determines in step S40 whether the current vehicle speed is lower than the vehicle speed limit. If it is determined in step S40 that the current vehicle speed is not lower than the vehicle speed limit (No in step S40), the target vehicle-speed control unit 20a sets the upper-limit vehicle speed V to the vehicle speed limit in step S41 and terminates the processing. By doing so, if the current vehicle speed is equal to or higher than the vehicle speed limit, the target vehicle-speed control unit 20a estimates the traffic light state at the time the vehicle, which travels at the vehicle speed limit, without considering allowable acceleration Ga, arrives at the traffic light location. The target vehicle-speed control unit 20a determines the estimated traffic light state as the traffic light state Sa.

If it is determined in step S40 that the current vehicle speed is lower than the vehicle speed limit (Yes in step S40), the target vehicle-speed control unit 20a calculates, in step S42, a distance Da that is the distance from the current position to the vehicle-speed-limit reaching location at which the vehicle speed reaches the vehicle speed limit when the vehicle accelerates from the current vehicle speed at the allowable acceleration Ga. In step S44, the target vehicle-speed control unit 20a determines whether the distance Da is shorter than a distance Dist. The distance Dist is the distance from the current position to the traffic light location.

If it is determined in step S44 that the distance Da is shorter than the distance Dist (Yes in step S44), the target vehicle-speed control unit 20a sets the upper-limit vehicle speed V to the vehicle speed limit for the distance after the vehicle-speed-limit reaching location in step S46 and terminates the processing. As a result, if the distance Da is shorter than the distance Dist, the target vehicle-speed control unit 20a obtains an estimated pattern 72d shown in FIG. 12. In the estimated pattern 72d, the vehicle travels to the vehicle-speed-limit reaching location (location that is distance Da away from the current position) by accelerating from the vehicle speed at the allowable acceleration Ga as indicated by an arrow 76d and, after the vehicle-speed-limit reaching location, the vehicle travels at the vehicle speed limit as indicated by an arrow 76e. The target vehicle-speed control unit 20a estimates the traffic light state at a time when the vehicle arrives at the traffic light location in this way as the traffic light state Sa. The target vehicle-speed control unit 20a also estimates the traffic light state when the vehicle travels at the current vehicle speed as the traffic light state S.

If it is determined in step S44 that the distance Da is not shorter than the distance Dist (No in step S44), the target vehicle-speed control unit 20a sets the upper-limit vehicle speed V to the speed, calculated by adding the current vehicle speed V0 to the product of the allowable acceleration Ga and the time t (V=V0+Ga×t), in step S48 and terminates the processing. That is, if the distance Da is not shorter than the distance Dist, the target vehicle-speed control unit 20a estimates, as the traffic light state Sa, the traffic light state at a time when the vehicle arrives at the traffic light location by accelerating from the current vehicle speed at the allowable acceleration Ga.

As shown in FIG. 11 and FIG. 12, the driving assisting apparatus 19 estimates the traffic light state Sa considering the vehicle speed limit limit and determines whether to pass through, or stop at, a traffic light location using the estimated traffic light state Sa and the traffic light state S estimated using the current vehicle speed, thus preventing a target vehicle speed range, which includes a vehicle speed at which the vehicle cannot travel due to the traffic regulations, from being notified. This relieves a driver of an unnecessary stress.

Although the driving assisting apparatus 19 in the embodiment described above displays a speed in the speed display area 48 of the display device 42 using an analog meter, the present invention is not limited to the display of a speed using an analog meter. The driving assisting apparatus 19 in the embodiment described above may display a speed in the speed display area 48 of the display device 42 using a digital meter. In this case, the speed display area, in which a speed is displayed numerically, includes a first area and a second area. The first area is an area where the current vehicle speed is displayed. The second area, located above the first area on the screen, is an area where a target vehicle speed range is displayed. Thus, the driving assisting apparatus 19 gives an effect equivalent to that described above, using a digital meter in the speed display area of the display device 42. Preferably, the driving assisting apparatus 19 displays the current vehicle speed, displayed in the first area of the speed display area, and the target vehicle speed range, displayed in the second display area, using different colors and/or different sizes. By doing so, the driving assisting apparatus 19 can prevent a driver from confusing the current vehicle speed with the target vehicle speed range.

It is preferable that the driving assisting apparatus 19 determine whether to pass through, or stop at, a traffic light location based on the current vehicle speed, the allowable acceleration Ga, and the allowable deceleration Gb and, in addition, calculate a target vehicle speed range based on the current vehicle speed, the allowable acceleration Ga, and the allowable deceleration Gb, the present invention is not limited to this determination method and the calculation method. The driving assisting apparatus 19 may determine whether to pass through, or stop at, an traffic light location based on the current vehicle speed, the allowable acceleration Ga, and the allowable deceleration Gb, but calculate a target vehicle speed range via processing other than the processing shown in FIG. 4. For example, as a target vehicle speed range, the driving assisting apparatus 19 may determine a vehicle speed range, in which the vehicle may pass through the traffic light location, in the whole time zone in which the color of the traffic light is green or in the whole time zone in which the color of the traffic light is green or yellow. In this case, too, the driving assisting apparatus 19 can also determine whether to pass through, or a stop at, a traffic light location properly, giving a driver an effect similar to that described above.

The driving assisting apparatus 19 may determine whether to pass through, or stop at, a traffic light location by performing processing other than the processing shown in FIG. 4 and calculate a target vehicle speed range based on the current vehicle speed, allowable acceleration Ga, and allowable deceleration Gb. For example, the driving assisting apparatus 19 may determine whether to pass through, or stop at, a traffic light location based only on the current vehicle speed. In this case, too, the driving assisting apparatus 19 can calculate a target vehicle speed range properly, giving a driver an effect similar to that described above.

Although the driving assisting apparatus 19 in the embodiment described above notifies about a target vehicle speed range, the present invention is not limited to notifying about a target vehicle speed range. The driving assisting apparatus 19 may notify a recommended traveling state using the control condition other than the target vehicle speed range or the vehicle speed. The driving assisting apparatus 19 may notify an accelerator opening degree instead of a vehicle speed or in addition to a vehicle speed.

Although the driving assisting apparatus 19 in the embodiment described above notifies a driver about a target vehicle speed range by displaying the target vehicle speed range in the speed display area, the present invention is not limited this assisting method. The driving assisting apparatus 19 in the embodiment described above is required only to notify a driver about a calculated recommended traveling state and therefore may use any notification method. For example, the driving assisting apparatus 19 may notify about a recommended traveling state via voice. Further, the driving assisting apparatus 19 may automatically control the driving condition such that the vehicle achieves a recommended traveling state.

What is claimed is:

1. A driving assisting apparatus that assists in driving a vehicle, the driving assisting apparatus comprising:
a vehicle speed sensor that detects a vehicle speed of the vehicle;
a control unit that determines a recommended traveling state based on a current vehicle speed detected by the vehicle speed sensor and at least one of an accelerated vehicle speed when the vehicle accelerates from the current vehicle speed at an allowable acceleration and a decelerated vehicle speed when the vehicle decelerates from the current vehicle speed at an allowable deceleration; and
an assisting unit that assists in driving the vehicle based on the recommended traveling state determined by the control unit.

2. The driving assisting apparatus according to claim 1, wherein the control unit determines the recommended traveling state based on at least one of a vehicle speed range from the current vehicle speed to the accelerated vehicle speed and a vehicle speed range from the decelerated vehicle speed to the current vehicle speed.

3. The driving assisting apparatus according to claim 1, wherein the assisting unit notifies about the recommended traveling state.

4. The driving assisting apparatus according to claim 1, further comprising:
a communication unit that acquires traffic light information about a change in display state of a traffic light installed ahead in a traveling direction of the vehicle; and
a position detection unit that detects relative position information between the vehicle and a traffic light location at which the traffic light is installed, wherein
the control unit determines the recommended traveling state based on the relative position information detected by the position detection unit and the traffic light information acquired by the communication unit.

5. The driving assisting apparatus according to claim 4, wherein the control unit changes at least one of the allowable acceleration and the allowable deceleration according to a light color displayed by the traffic light.

6. The driving assisting apparatus according to claim 4, wherein:
the control unit estimates a normal arrival time, at which the vehicle arrives at the traffic light location when the vehicle travels at the current vehicle speed, and an accelerated arrival time at which the vehicle arrives at the traffic light location when the vehicle accelerates from the current vehicle speed at the allowable acceleration; and
if a passable display period, during which the traffic light permits the vehicle to pass through, is included in a first period from the accelerated arrival time to the normal arrival time, the control unit determines the recommended traveling state based on a passable vehicle speed range that is a vehicle speed range at which the vehicle is permitted to pass through the traffic light location.

7. The driving assisting apparatus according to claim 6, wherein the control unit sets a vehicle speed range required to pass through the traffic light location during a period in which the passable display period overlaps with the first period to the passable vehicle speed range.

8. The driving assisting apparatus according to claim 6, wherein the control unit sets a vehicle speed at the accelerated arrival time to an upper-limit speed of the passable vehicle speed range.

9. The driving assisting apparatus according to claim 6, wherein:
the assisting unit notifies about a target vehicle speed range as the recommended traveling state; and
the control unit sets the passable vehicle speed range to the target vehicle speed range.

10. The driving assisting apparatus according to claim 4. wherein:
the control unit estimates a normal arrival time, at which the vehicle arrives at the traffic light location when the vehicle travels at the current vehicle speed. and a decelerated arrival time at which the vehicle arrives at the traffic light location when the vehicle decelerates from the current vehicle speed at the allowable deceleration; and
if a passable display period, during which the traffic light permits the vehicle to pass through, is included in a second period from the normal arrival time to the decelerated arrival time, the control unit determines the recommended traveling state based on a passable vehicle speed range that is a vehicle speed range at which the vehicle is permitted to pass through the traffic light location.

11. The driving assisting apparatus according to claim 10, wherein the control unit sets a vehicle speed range required to pass through the traffic light location during a period in which the passable display period overlaps with the second period to the passable vehicle speed range.

12. The driving assisting apparatus according to claim 10, wherein the control unit sets a vehicle speed at the decelerated arrival time to a lower-limit speed of the passable vehicle speed range.

13. The driving assisting apparatus according to claim 10, wherein:
the assisting unit notifies about a target vehicle speed range as the recommended traveling state; and
the control unit sets the passable vehicle speed range to the target vehicle speed range.

14. The driving assisting apparatus according to claim 1, wherein the control unit acquires information about a vehicle speed limit and determines the recommended traveling state such that a vehicle speed corresponding to the recommended traveling state does not exceed the vehicle speed limit.

15. The driving assisting apparatus according to claim 1, wherein the control unit determines a target vehicle speed range as the recommended traveling state.

16. The driving assisting apparatus according to claim 14, wherein the assisting unit notifies about the target vehicle speed range.

17. A driving assisting method for assisting in driving a vehicle, the driving assisting method comprising:
detecting a vehicle speed of the vehicle;
determining a recommended traveling state based on the detected current vehicle speed and at least one of an accelerated vehicle speed when the vehicle accelerates from the current vehicle speed at an allowable acceleration and a decelerated vehicle speed when the vehicle decelerates from the current vehicle speed at an allowable deceleration; and
assisting in driving the vehicle based on the recommended traveling state.
